(19) United States
(12) Patent Application Publication
(10) Pub. No.: US 2017/0100851 A1
(43) Pub. Date: Apr. 13, 2017

(54) Pin for Pin Ejector System for a Rotary Cutting Die Arrangement and Associated Methods

(71) Applicant: Roto-Die Company, Inc., St. Louis, MO (US)

(72) Inventors: Ashok Midha, Rolla, MO (US); Andrew Wendel, Florissant, MO (US); Pratheek B. Prasanna, Rolla, MO (US); Sushrut Bapat, Rolla, MO (US); Phil Schneider, Saint Louis, MO (US); Paul Vitale, Rolla, MO (US); Nathan Hickle, Rolla, MO (US); Michael Austell, Rolla, MO (US); Scott Lawrence Kuhl, Saint Charles, MO (US)

(21) Appl. No.: 14/879,563

(22) Filed: Oct. 9, 2015

(51) Int. Cl. B26F 1/38; B26D 7/26

(52) U.S. Cl. CPC B26F 1/384; B26D 7/265

(57) ABSTRACT

A pin may be arranged in a hole located on an outer diameter surface of a cylinder of a rotary die cutting arrangement. The pin proximal end may be received in the hole and the pin distal end may project from an outer surface of the cylinder. The pin proximal end has a boss. The pin has a longitudinal slit extending from the proximal end toward the distal end. The slit has a width and length dimensioned to provide the proximal end with sufficient resiliency to allow the proximal end to be compressed to a position where the boss of the pin proximal end has a diameter less than the diameter of the hole to allow the boss to pass through the hole, and release to a position where the diameter of the boss is greater than the hole diameter to retain the pin in the hole.

### BACKGROUND AND SUMMARY

The disclosure relates to a pin eject system in a rotary cutting die arrangement comprising a rotary die cutting cylinder and an anvil roll with a media passing therebetween. The rotary cutting die arrangement is used in the converting industry to cut parts from a media passing between the two cylinders. The pin eject system facilitates the separation of the cut part from the media.

In one aspect, the disclosure relates to a rotary die cutting cylinder of the rotary die cutting arrangement with a pin ejection feature in a die cavity. The ejector pins project through holes in the die ejection pin cavity. The pins are located in a cutting die area of the cutting cylinder and are biased outward by a compressible, springing core disposed in the bore of the rotary cutting cylinder. During cutting, the media is compressed in the cavity between the rotary cutting cylinder and the anvil roll, and cut. The portion of the media in the cavity pushes against the ejector pins and the pins retract through their holes in the die cavity against the compressible core. As the die cavity rotates away from the anvil roll, the pins move outward by the biasing force of the compressible core and eject the part (or die cut slug) from the cavity. Thus, the pin eject system prevents the build-up of small die cut slugs in die cavities of the die.

In another aspect, the disclosure relates to an anvil roll of the rotary die cutting arrangement with a pin ejection feature that cooperates with a die cavity of a rotary cutting cylinder to maintain the cut media within the die cavity or to separate the media from the cut media within the die cavity. In one example, when the anvil rotates, the pin eject feature of the anvil roll comes into register with die cavity of the rotary cutting cylinder. The pins project into a cutting die area of the cutting cylinder and are biased outward by a compressible, springing core disposed in the bore of the anvil roll. The ejector pins project through holes in the anvil roll outer surface and comes into register with the die cavity at selected points during cutting. As the media is compressed in the cavity between the rotary cutting cylinder and the anvil roll, and cut, the pins push the material into the die cavity. As another example, the pins may project outward from the anvil roll in areas outside of the die cavity during cutting. As the media is compressed in the cavity between the rotary cutting cylinder and the anvil roll, and cut, the pins push the material outside of the die cavity away from the material within the die cavity, thereby facilitating the removal of the die cut portion from the remaining portion of the media outside of the cavity.

More in particular, the disclosure is directed to the ejector pin that has features that facilitate the assembly of the pin with the cylinder.

### BRIEF DESCRIPTION OF THE DRAWINGS

FIG. 1 is an exploded view of a rotary die cutting cylinder showing cutting blades on an outer diameter of the cylinder defining a plurality of die cavities, ejector pins for the die cavities, a compressible core, and axial opposite journal bearers.

FIG. 2 is a partial cross-sectional view of one ejector pin engaging an inner diameter surface of the rotary die cutting cylinder and another ejector pin pushing against the compressible core.

FIG. 3 is a perspective view of an ejector pin of FIG. 1.

FIG. 4 is a side view of the ejector pin of FIG. 3.

FIG. 5 is an enlarged left end view of the ejector pin of FIG. 4.

FIG. 6 illustrates a kit comprising a plurality of ejector pins of the type shown in FIGS. 3-5 in addition to instructions for assembly of the pins with a rotary cylinder having die cavities and a pin eject system.

### DETAILED DESCRIPTION

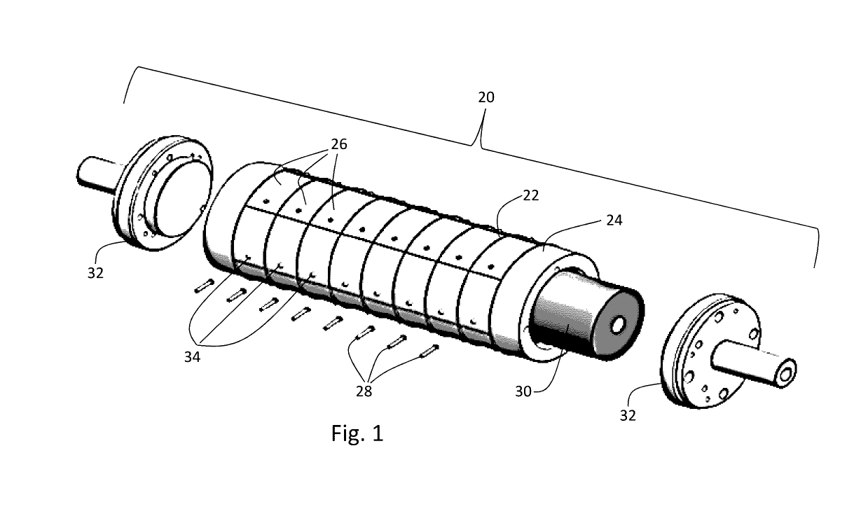

FIG. 1 is an exploded view of an exemplary arrangement of a rotary die cutting cylinder assembly 20, showing cutting blades 22 on an outer diameter of a cylinder body 24 defining a plurality of die cavities 26, ejector pins 28 for the die cavities, a compressible core 30, and axial opposite journal bearers 32. The compressible core 30 may be a sleeve of polyurethane or rubber-like material. The journal bearers 32 may allow the rotary cutting cylinder assembly 20 to rotate relative to the equipment in which the rotary cutting cylinder assembly is installed. The cutting blades 22 and die cavities 26 may be disposed directly on the outer diameter surface of the cylinder body 24. In the alternative, the rotary die cutting cylinder assembly 20 may include a flexible die (not shown), and the cylinder body 24 may be magnetic to allow mounting of a flexible die. In such an arrangement, the cutting blades 22 and die cavities 26 may be formed in the flexible die. One or more die cavities 26 may have one or more ejector pin locator holes 34. The ejector pin locator holes 34 may be in positions in the die cavity to maximize the ability of the ejector pin 28 to eject a slug from the die cavity 26 once the media is cut.

In the example of the anvil roll with pin eject feature, the anvil may have the same general construction as the rotary die cutting cylinder shown in FIG. 1, but without a die cavity or cutting surfaces. Depending upon the application, the pins may project from the anvil roll outer diameter surface in areas that come in register with the die cavities of the rotary die cutting cylinder at selected points of rotation of the anvil roll and rotary die cutting cylinder or areas outside of the die cavities of the rotary die cutting cylinder at selected points of rotation of the anvil roll and rotary die cutting cylinder.

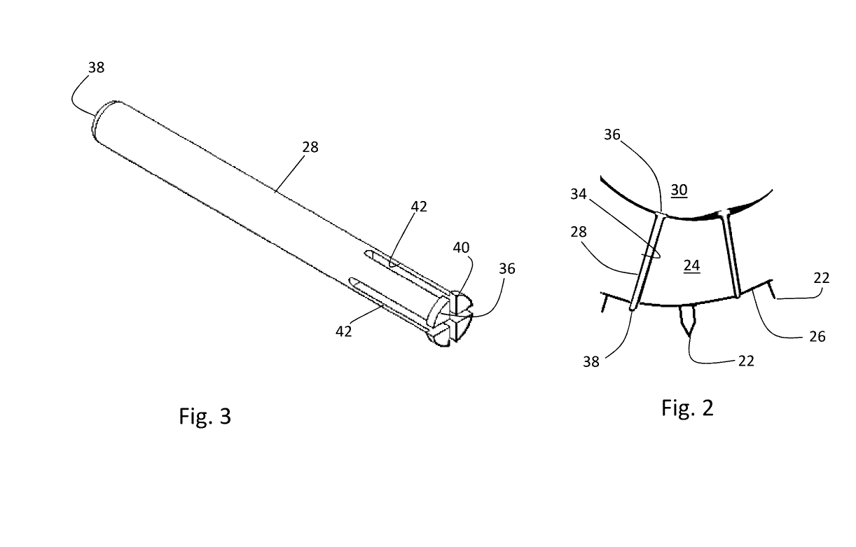

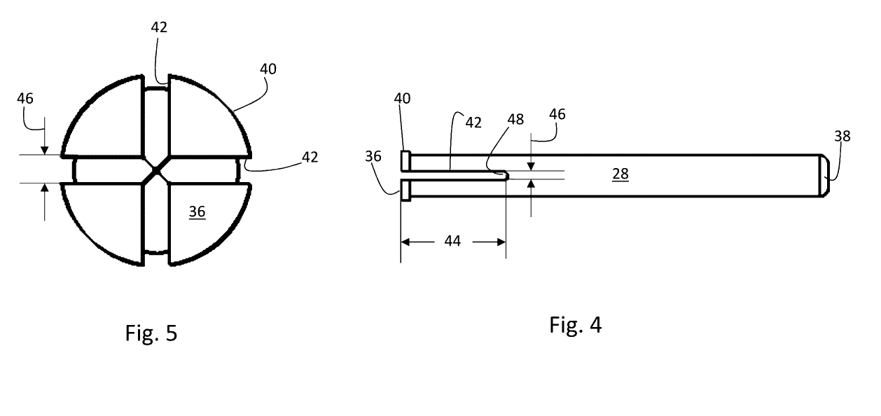

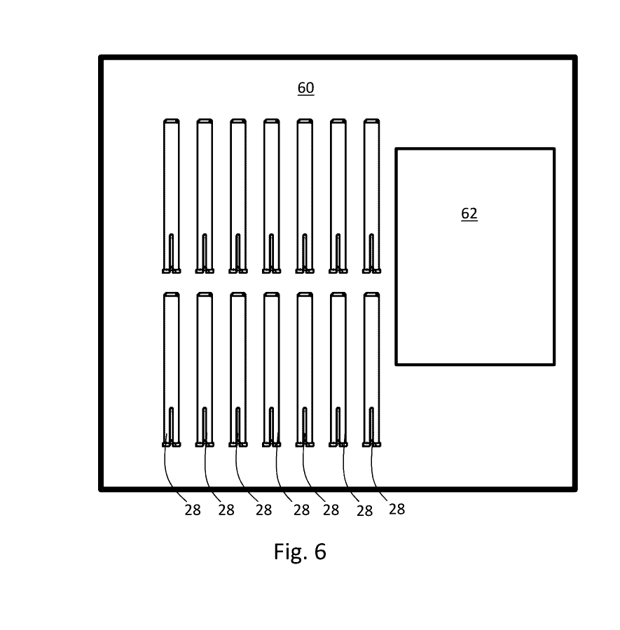

The ejector pin 28 comprises an elongate member with proximal and distal ends 36,38. The pin proximal end 36 is configured to be received in the ejector pin locator hole 34 such that the pin distal end 38 projects from the outer surface of the cylinder body 24 in the cavity 26 when the pin 28 is installed with the rotary die cutting cylinder body. The pin proximal end 36 may have an enlarged diameter portion 40. For instance, as shown in the drawings, the enlarged diameter portion 40 may comprise an annular boss extending circumferentially around the pin proximal end. Other shapes and configurations may be used, such as tapers, hooks, spokes, tabs, tangs, radially extending lobes, etc. The enlarged diameter portion 40 may form a shoulder which engages an inner diameter surface of the rotary cutting cylinder to retain the pin in the ejector pin locator hole for instance as shown in FIG. 2. The enlarged diameter 40 portion may also engage a counter bored portion of the locator hole 34. The pin distal end 38 may be rounded to reduce the tendency of adhesive to adhere to the ejector pin and to limit the ejector pin from penetrating the slug and retaining the slug in the cavity. The pin proximal end 36 may have one or more longitudinal slits or slots 42 extending from the proximal end towards the distal end. The slit 42 may extend through the proximal end 36 and through the enlarged diameter portion 40. The slit 42 may have a root 48 shaped to eliminate stress concentration points. The slit 42 may be machined with a conventional cutter, for instance, a saw or, a rotary mechanical or abrasive cutting wheel. The slit 42 may also be formed by electrical discharge machining (EDM; RAM or wire), laser cutting, or water jet cutting. As will be described below, the slit 42 enables the proximal end 36 of pin to compress to a diameter that allows the pin to be installed with the cutting cylinder.

In accordance with one aspect of the disclosure, the pin 28 may be assembled with the cutting cylinder body 24 by forcing the pin into the ejector pin locator hole 34 from the outer diameter side of the cutting cylinder body instead of from the bore of the rotary die cutting cylinder body. The ejector pin locator hole 34 may cause compression of the proximal end 36 as the pin is introduced to the ejector pin locator hole. The ejector pin locator hole 34 may have slight lead-in taper to facilitate compression of the proximal end 36. In addition to or in the alternative to, the enlarged diameter portion 40 of the pin proximal end 36 may have a beveled or chamfered edge to facilitate compression of the proximal end when the pin is introduced to the ejector pin locator hole 34. While the drawings show two longitudinal slits 42 extending from the proximal end 36 through the enlarged diameter portion 40 and along a length of the pin, one slit or more than two slits may be provided. The number of slits and their length 44 and width 46 may be dimensioned to provide the proximal end 36 with sufficient resiliency to allow the proximal end to be compressed to a lesser diameter where the enlarged portion 40 of the proximal end slides through the ejector pin locator hole 34, and released to a released diameter where the enlarged portion expands outward to engage the rotary die cutting cylinder body 24, for instance, an inner diameter surface of the rotary die cutting cylinder body adjacent to the ejector pin locator hole. The pin material may also be selected for the same effects. The pin material and slot dimensions may be selected to allow the proximal end to elastically and springingly compress to a diameter to allow the enlarged diameter portion 40 to pass through the ejector pin locator hole 34, and once the pin proximal end enlarged diameter portion passes through the ejector pin locator hole to the inner diameter of the rotary die cutting cylinder, to elastically and springingly spring diametrical outward so that the enlarged diameter portion engages the rotary die cutting cylinder body. The pin material and slot dimensions may be selected to allow for some plastic deformation as the pin proximal end is compressed to a diameter to allow the enlarged diameter portion 40 to pass through the ejector pin locator hole 34. The amount of plastic deformation may be limited so that once the pin proximal end enlarged diameter portion passes through the ejector pin locator hole to the inner diameter of the rotary die cutting cylinder, the proximal end springs outward to retain the pin in the ejector pin locator hole. The pin material and slot dimensions may be selected to reduce the effects of the pin buckling as the pin is compressed along its length between the anvil roll and compressible core. While the pin proximal end is shown with outer surfaces generally co-axial with the center axis of the pin, the pin proximal may be outwardly flared to increase the springing tension of the pin proximal end once it passes though the ejector pin locator hole. While the pin is shown in a monolithic construction, the pin may be formed from one or more materials. For instance, the pin proximal end may be formed from materials that provide for more resiliency than the distal end. The proximal end may be formed from materials that have good spring capabilities and/or are sufficient to withstand buckling. The distal end may be formed from materials that limit the amount of adhesive that may be attracted to the distal end from the cut media.

One example of an 0.040″ Φ ejector pin may be as follows:
Pin length—1.000 inches
Pin diameter—0.040 inches
Boss diameter—0.050 inches
Boss length—0.020 inches
Slot length—0.100 inches
Slot width—0.008 inches
Proximal end radius—0.010 inches
Slot root radius—0.004 inches
Two slots located 90 degrees apart
Material ASTM 4140 steel

Another example of an 0.070″ Φ ejector pin may be as follows:
Pin length—1.000 inches
Pin diameter—0.070 inches
Boss diameter—0.090 inches
Boss length—0.020 inches
Slot length—0.200 inches
Slot width—0.020 inches
Proximal end radius—0.015 inches
Slot root radius—0.010 inches
Two slots located—90 degrees apart
Material ASTM 4140 steel

Another example of an 0.096″ Φ ejector pin may be as follows:
Pin length—1.000 inches
Pin diameter—0.096 inches
Boss diameter—0.116 inches
Boss length—0.020 inches
Slot length of—0.250 inches
Slot width of—0.020 inches
Proximal end radius—0.020 inches
Slot root radius—0.010 inches
Two slots located 90 degrees apart
Material ASTM 4140 steel

Another example of an 0.125″ Φ ejector pin may be as follows:
Pin length—1.500 inches
Pin diameter—0.125 inches
Boss diameter—0.145 inches
Boss length—0.020 inches
Slot length—0.300 inches
Slot width—0.020 inches
Proximal end radius—0.025 inches
Slot root radius—0.010 inches
Two slots located 90 degrees apart
Material ASTM 4140 steel

As described above, the pin proximal end 36 may compress to allow the enlarged diameter portion 40 to pass through the pin locator hole 34, and once the enlarged diameter portion passes through the hole, the enlarged diameter portion of the proximal end may extend outward to engage the cylinder body 24. In the alternative, the enlarged diameter portion of the pin proximal end may be plastically deformed once positioned past the pin locator hole so that the plastically deformed portion of the proximal end, may extend outward to engage the cylinder body 24. The pins may be removed by removing the compressible core from the bore of the cylinder body and pushing the pin through the ejector pin locator hole so that the pin distal end passes into the bore of the cylinder body. The pins may be mounted in an anvil roll in a like manner.

In accordance with another aspect of the disclosure, the ejector pins 28 may be supplied in a kit 60 together with a flexible die and/or rotary die cutting cylinder assembly 20 and/or anvil roll and/or its component parts. Operators using the rotary die cutting cylinder assembly 20 may access the kit 60 and be directed through instructions 62 for arranging the ejector pins 28 in one or more holes of the die cavity depending upon the type of die utilized. For an anvil roll, the operator may be directed through instructions to arrange the ejector pins 28 in one or more holes that match with the die cavity, or are outside of the die cavity, depending upon the type of anvil roll and rotary die cutting cylinder utilized. The instructions may include text or other indicia directing use of the ejector pins 28, a flexible die, and/or rotary die cutting cylinder assembly 20 and/or anvil roll and/or its component parts. The ejector pins 28 may be sold separately, in the kit 60, or distributed together with the rotary die cutting cylinder assembly, anvil roll, compressible core, and/or flexible die. The ejector pins may be sold separately and provided with sufficient instructions directing the user to insert the ejector pins in the die cavities of the rotary die cutting cylinder or anvil roll as described previously. In connection with the sale or distribution of ejector pins, flexible die, or compressible core, the user (e.g., a purchaser of the ejector pins) is instructed that the purpose of the ejector pins, flexible die, or compressible core, is to remove, and install the components in a rotary die cutting cylinder and/or anvil roll as described previously. Thus, the user is induced to replace, remove, and install the components in a rotary die cutting cylinder and/or anvil roll as described previously.

As is seen in the foregoing description, the pin and its method of installation allow for maintaining the concentricity of the die which contributes to the quality of the products being produced by the process. The pin and its method of installation are versatile and allow for use in a variety of different die and rotary cutter configurations, for instance, cutting blade size and dimensions, ejector pin hole locations and sizes, cylinder diameters, and differently shaped die cavities and ejector pin sizes. The pin also has less tendency to be adversely affected by adhesive. The pin is relatively inexpensive to manufacture and may be easily assembled with the die cutting cylinder.

The embodiments were chosen and described in order to best explain the principles of the disclosure and their practical application to thereby enable others skilled in the art to best utilize the disclosed embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A pin configured to be received in a hole located on an outer diameter surface of a cylinder of a rotary die cutting arrangement comprising a rotary die cutting cylinder and an anvil roll, the pin being configured to engage a media passing between the rotary die cutting cylinder and the anvil roll, the pin comprising proximal and distal ends with the proximal end being configured to be received in the hole and the distal end projecting from an outer diameter surface of the cylinder when the pin is installed with the cylinder, the proximal end of the pin having a boss extending circumferentially around the pin proximal end, the pin having a longitudinal slit extending from the proximal end toward the distal end, the slit having a width and length dimensioned to provide the proximal end with sufficient resiliency to allow the proximal end to be compressed to a position where the boss of the pin proximal end has a diameter less than the diameter of the hole to allow the boss to pass through the hole, and release to a position where the diameter of the boss of the pin proximal end is greater than the hole diameter to retain the pin in the hole.

2. The pin of claim 1 further comprising a second slit that has a width and length dimensioned such that the slits provide the proximal end with sufficient resiliency to allow the proximal end to be compressed to a position where the boss of the pin proximal end has a diameter less than the diameter of the hole to allow the boss to pass through the hole, and release to a position where the diameter of the boss of the pin proximal end is greater than the hole diameter to retain the pin in the hole.

3. The pin of claim 2 wherein the slits are perpendicular to each other.

4. A pin configured to be received in a hole located on an outer diameter surface of a cylinder of a rotary cutting die arrangement comprising a rotary die cutting cylinder and an anvil roll, the pin being configured to engage a media passing between the rotary die cutting cylinder and the anvil roll, the pin comprising proximal and distal ends with the proximal end being configured to be received in the hole and the distal end projecting from an outer surface of the cylinder from the cavity when the pin is installed with the cylinder, the proximal end of the pin being compressible to a dimension to allow the pin proximal end to pass through the hole, the proximal end being resilient to return to a dimension where pin proximal end is greater than the hole diameter to retain the pin in the hole.

5. The pin of claim 4 wherein the pin has at least one longitudinal slit extending from the proximal end toward the distal end.

6. The pin of claim 4 wherein the proximal end has an enlarged diameter portion that retains the pin in the hole when the enlarged diameter portion passes through the hole.

7. A cylinder of a rotary cutting die arrangement, wherein the rotary cutting die arrangement comprises a rotary die cutting cylinder and an anvil roll, the cylinder having an outer diameter surface and a pin for engaging a media passing between the rotary die cutting cylinder and the anvil roll, the pin comprising proximal and distal ends with the proximal end being configured to be received in a hole located in the cylinder outer diameter surface and the distal end projecting from the outer diameter surface of the cylinder when the pin is installed with the cylinder, the proximal end of the pin being compressible to a dimension to allow the pin proximal end to pass through the hole, the proximal end being resilient to return to a dimension where pin proximal end is greater than the hole diameter to retain the pin in the hole.

8. The cylinder of claim 7 wherein the pin has at least one longitudinal slit extending from the proximal end toward the distal end.

9. The cylinder of claim 7 wherein the proximal end has an enlarged diameter portion that retains the pin in the hole when the enlarged diameter portion passes through the hole.

10. The cylinder of claim 7 wherein the cylinder has a hollow interior defined by an inner diameter surface.

11. The cylinder of claim 10 wherein the proximal end releases to enable the pin proximal end to expand outward and engage the inner diameter surface of the cylinder adjacent to the hole.

12. A method comprising:
accessing a cylinder of a rotary cutting die arrangement comprising a rotary die cutting cylinder and an anvil roll;
accessing a pin for engaging a media passing between the rotary die cutting cylinder and the anvil roll; and
inserting the pin in a hole located in an outer diameter surface of the cylinder by placing a proximal end of the pin in register with the hole, compressing the pin proximal end to a dimension where the pin proximal end passes into the hole, and pushing the pin into the hole to a position wherein the pin proximal end clears the hole and expands outward to engage the cylinder and be retained in the hole.

13. The method of claim 12 wherein the step of accessing the pin includes accessing a pin with at least one longitudinal slit extending from the proximal end toward the distal end.

14. The method of claim 12 wherein the step of accessing the pin includes accessing a pin where the pin proximal end has an enlarged diameter portion that retains the pin in the hole when the enlarged diameter portion passes through the hole.

15. The method of claim 12 wherein the step of accessing the cylinder includes accessing a rotary die cutting cylinder.

16. The method of claim 12 wherein the step of inserting the pin in a hole includes pushing the pin into the hole to a position to enable the pin proximal end to expand outward and engage an inner diameter surface of the cylinder adjacent to the hole.

17. A method comprising:
directing a user to:
access a cylinder of a rotary cutting die arrangement comprising a rotary die cutting cylinder and an anvil roll;
access a pin for engaging a media passing between the rotary die cutting cylinder and the anvil roll; and
insert the pin in a hole located in an outer diameter surface of the cylinder by placing a proximal end of the pin in register with the hole, compressing the pin proximal end to a dimension where the pin proximal end passes into the hole, and pushing the pin into the hole to a position wherein the pin proximal clears the hole and expands outward to engage the cylinder and be retained in the hole.

18. The method of claim 17 wherein the step of directing the user to access the pin includes directing the user to access a pin with at least one longitudinal slit extending from the proximal end toward the distal end.

19. The method of claim 17 wherein the step of directing the user to access the pin includes directing the user to access a pin where the pin proximal end has an enlarged diameter portion that retains the pin in the hole when the enlarged diameter portion passes through the hole.

20. The method of claim 17 wherein the step of directing the user to access the cylinder includes directing the user to access a rotary die cutting cylinder.

21. The method of claim 17 wherein the step of directing the user to insert the pin in the hole includes directing the user to push the pin into the hole to a position to enable the pin proximal end to expand outward and engage an inner diameter surface of the cylinder adjacent to the hole.
